(19) United States
(12) Patent Application Publication
(10) Pub. No.: US 2023/0351235 A1
(43) Pub. Date: Nov. 2, 2023

(54) SYSTEMS AND METHODS FOR PIEZOELECTRIC CONTROL OF SPIN QUANTUM MEMORIES

(71) Applicants: The MITRE Corporation, McLean, VA (US); National Technology & Engineering Solution of Sandia, LLC, Albuquerque, NM (US); MIT - Massachusetts Institute of Technology

(72) Inventors: Genevieve CLARK, McLean, VA (US); Matthew KOPPA, McLean, VA (US); Kevin CHEN, McLean, VA (US); Andrew LEENHEER, McLean, VA (US); Linsen LI, McLean, VA (US); Daniel DOMINQUEZ, McLean, VA (US); Mark DONG, McLean, VA (US); Matthew SAHA, McLean, VA (US); Andrew GOLTER, McLean, VA (US); Gerald GILBERT, McLean, VA (US); Matthew EICHENFIELD, McLean, VA (US); Dirk ENGLUND, McLean, VA (US)

(73) Assignees: The MITRE Corporation, McLean, VA (US); National Technology & Engineering Solution of Sandia, LLC, Albuquerque, NM (US); MIT - Massachusetts Institute of Technology, Cambridge, MA (US)

(21) Appl. No.: 18/140,813

(22) Filed: Apr. 28, 2023

Related U.S. Application Data
(60) Provisional application No. 63/336,873, filed on Apr. 29, 2022.

(51) Int. Cl. G06N 10/20; G02F 1/01; G06E 3/00

(52) U.S. Cl. CPC G06N 10/20; G02F 1/0128; G02F 1/011; G02F 1/0102; G06E 3/005; G02F 2202/32

(57) ABSTRACT

A method for controlling a qubit encoded in an atom-like defect in a solid-state host may comprise applying an electrical signal to a piezoelectric cantilever that is mechanically coupled to a photonic waveguide comprising one or more embedded point defect sites. The photonic waveguide may be optically coupled to a photonic chip. Applying the electrical signal to the piezoelectric cantilever may induce movement in the piezoelectric cantilever, which may induce a strain in the photonic waveguide. The applied electrical signal may be determined by a defect site with excitation light, measuring a frequency of a photon emitted by the excited defect site, determining a frequency shift based on the measured frequency of the emitted photon, and determining the electrical signal to be applied to the piezoelectric cantilever based on the frequency shift.

### CROSS REFERENCE TO RELATED APPLICATION

This application claims the benefit of U.S. Provisional Application No. 63/336,873, filed Apr. 29, 2022, the entire contents of which is incorporated herein by reference.

This invention was made under CRADA/PTS No. SC19/1945.00.00 between The MITRE Corporation and Sandia National Laboratories operated for the United States Department of Energy. The Government has certain rights in this invention.

### FIELD OF THE DISCLOSURE

The present disclosure relates generally to quantum computing. More specifically, the present disclosure relates to systems and methods for controlling qubits encoded in atom-like defect sites in a solid-state host material

### BACKGROUND OF THE DISCLOSURE

Quantum computing is a type of computation that employs physical properties of quantum states to perform calculations. As a result of their ability to harness quantum mechanical properties like superposition, quantum computers have many potential advantages over classical computing systems. In particular, quantum computers are believed to be capable of performing certain calculations much faster than classical computers.

The basic unit of quantum memory is the quantum bit, or “qubit”. Quantum computers perform calculations by operating on the quantum states of qubits in order to manipulate and extract information. However, inherent properties of quantum systems such as qubits make controlling qubits for extended periods of time difficult. As such, a primary challenge in the development of scalable, functioning quantum computing systems lies in the ability to accurately and efficiently control the quantum states of qubits.

### SUMMARY OF THE DISCLOSURE

Qubits can be physically represented in quantum computing hardware by any two-state quantum system. Multiple promising physical representations encode qubits in atom-like defect sites in solid state host materials. This class of qubit implementations, referred to herein as “solid state qubit systems”, includes qubits encoded in point defects in diamond, qubits encoded in defects in silicon carbide, and quantum dot implementations. Solid state qubit systems possess desirable physical properties which may allow them to be effectively implemented on a large scale in quantum computing systems. In particular, many solid-state qubit systems are sensitive to mechanical strain in the solid structure.

Described herein are systems and methods for controlling qubits encoded in atom-like defect sites in a solid-state host using a piezoelectric cantilever. The systems and methods of the present disclosure allow for high frequency, bi-directional tuning of the frequency of photons emitted from the defect site, thus providing a high level of control over the quantum states of the qubits. In one or more examples, the systems and methods of the present disclosure may be implemented in cryogenic environments.

A photonic device may comprise a photonic chip, a piezoelectric cantilever, and a photonic waveguide comprising one or more embedded point defect sites. The photonic waveguide may be optically coupled to the photonic chip and the photonic waveguide may be mechanically coupled to the piezoelectric cantilever such that movement of the piezoelectric cantilever induces a strain in the photonic waveguide.

In one or more examples of the photonic device, applying an electrical signal to the piezoelectric cantilever causes the cantilever to move.

In one or more examples of the photonic device, a direction and a magnitude of movement of the piezoelectric cantilever depend on a voltage of the applied electrical signal.

In one or more examples of the photonic device, the piezoelectric cantilever comprises a piezoelectric layer, a first electrode layer disposed on a first side of the piezoelectric layer, a second electrode layer disposed on a second side of the piezoelectric layer, and a base layer disposed beneath the piezoelectric layer, the first electrode, and the second electrode.

In one or more examples of the photonic device, the piezoelectric layer comprises aluminum nitride.

In one or more examples of the photonic device, the first and second electrode layers are collectively configured to apply an electric field across the piezoelectric layer.

In one or more examples of the photonic device, the first and second electrode layers are formed from aluminum.

In one or more examples of the photonic device, the base layer comprises silicon dioxide.

In one or more examples of the photonic device, the base layer comprises amorphous silicon.

In one or more examples of the photonic device, the piezoelectric cantilever comprises an optical layer, wherein at least a portion the photonic waveguide is embedded within the optical layer, and the optical layer comprises a binding layer that surrounds a portion of the photonic waveguide embedded within the optical layer and is configured to mechanically couple the portion of the photonic waveguide to the piezoelectric layer.

In one or more examples of the photonic device, the photonic waveguide is formed from diamond.

In one or more examples of the photonic device, the point defect sites comprise Group IV defect sites.

In one or more examples of the photonic device, the point defect sites comprise tin vacancy (SnV) defect sites.

In one or more examples of the photonic device, the point defect sites are configured to emit photons when excited by a light source.

In one or more examples of the photonic device, a frequency of the photons emitted by the point defect sites depends on the strain in the photonic waveguide induced by the movement of the piezoelectric cantilever.

A method may comprise applying an electrical signal to a piezoelectric cantilever. The piezoelectric cantilever may be mechanically coupled to a photonic waveguide comprising one or more embedded point defect sites and the photonic waveguide may be optically coupled to a photonic chip. Applying the electrical signal to the piezoelectric cantilever may induce movement in the piezoelectric cantilever. The movement of the piezoelectric cantilever may induce a strain in the photonic waveguide.

In one or more examples of the method, applying the electrical signal comprises exciting a defect site of the one or more embedded point defect sites with excitation light, measuring a frequency of a photon emitted by the excited defect site, determining a frequency shift based on the measured frequency of the emitted photon, and determining the electrical signal to be applied to the piezoelectric cantilever based on the frequency shift.

In one or more examples of the method, determining the frequency shift comprises comparing the measured frequency of the emitted photon to a reference frequency.

In one or more examples of the method, the reference frequency is associated with a desired quantum state for a qubit encoded in the defect site.

In one or more examples of the method, the electrical signal comprises a direct current (DC) signal.

In one or more examples of the method, the electrical signal comprises an alternating current (AC) signal.

In one or more examples of the method, a frequency of the AC signal is approximately equal to a mechanical resonance frequency of the piezoelectric cantilever.

In one or more examples of the method, a voltage of the alternating current signal is approximately equal to 0.5 V.

In one or more examples, the method comprises applying a magnetic field to a defect site of the one or more point defect sites using a permanent magnet, exciting the defect site from a first spin state to a second spin state, and applying the electrical signal to the piezoelectric cantilever, wherein the electrical signal comprises an alternating current signal with a frequency approximately equal to a separation frequency between the first spin state and the second spin state.

In one or more examples of the method, the magnetic field is oriented perpendicular to a dipole axis of the defect site.

A non-transitory computer readable storage medium may store instructions that, when executed by one or more processors of an electronic device, cause the device to apply an electrical signal to a piezoelectric cantilever. The piezoelectric cantilever may be mechanically coupled to a photonic waveguide comprising one or more embedded point defect sites, and the photonic waveguide may be optically coupled to a photonic chip. Applying the electrical signal to the piezoelectric cantilever may induce movement in the piezoelectric cantilever. The movement of the piezoelectric cantilever induces a strain in the photonic waveguide.

### BRIEF DESCRIPTION OF THE FIGURES

The invention will now be described, by way of example only, with reference to the accompanying drawings.

FIG. 1 illustrates a quantum computing system according to one or more examples of the present disclosure.

FIG. 2 illustrates an exemplary solid-state host according to one or more examples of the present disclosure.

FIG. 3 illustrates an exemplary atom-like defect in a solid-state host according to one or more examples of the present disclosure.

FIG. 4 illustrates a top view of an exemplary system for piezoelectric control of qubits encoded in an atom-like defect site according to one or more examples of the present disclosure.

FIG. 5 illustrates a side view of an exemplary system for piezoelectric control of qubits encoded in atom-like defect sites according to one or more examples of the present disclosure.

FIG. 6A illustrates exemplary deformations of a diamond waveguide caused by deflections of a piezoelectric cantilever according to one or more examples of the present disclosure.

FIG. 6B illustrates data showing relationships between an amount of voltage applied to a piezoelectric cantilever, the magnitude of the displacement of the piezoelectric cantilever from its equilibrium position, and the amount of shift in the frequency of the photons emitted by a group IV defect site in the diamond waveguide being deformed by the piezoelectric cantilever.

FIG. 7 illustrates an exemplary cross-section of a piezoelectric cantilever according to one or more examples of the present disclosure.

FIG. 8 illustrates an exemplary method for piezoelectric control of a qubit encoded in an atom-like defect site according to one or more examples of the present disclosure.

FIG. 9 illustrates an exemplary system for piezoelectric control of a plurality of qubits encoded in a plurality of atom-like defect sites according to one or more examples of the present disclosure.

FIG. 10 illustrates an exemplary alternative system for piezoelectric control of a plurality of qubits encoded in a plurality of atom-like defect sites according to one or more examples of the present disclosure.

FIG. 11A illustrates an exemplary piezoelectric cantilever system driven by an AC signal according to one or more examples of the present disclosure.

FIG. 11B illustrates data showing a relationship between a driving frequency of a piezoelectric cantilever and a magnitude of a frequency shift induced on photons emitted from a group IV defect site.

FIGS. 12A-12R illustrate diagrams and data of an exemplary implementation of system for piezoelectric control of a plurality of qubits encoded in a plurality of tin defect sites.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes”, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure, in one or more examples, also relates to a device for performing the operations herein. This device may be specially constructed for the required purposes, or it may comprise a general purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

Classical computers perform calculations using information represented by binary digits (or “bits” for short). Each bit in a classical computing system can occupy one of two discrete states: a first state (“0”) or a second state (“1”). In the absence of any external forces, a classical system such as a bit will occupy a single, well-defined state indefinitely. Quantum computers, on the other hand, perform calculations using information encoded in the quantum states of two-state quantum systems called “quantum bits” (or “qubits” for short). A quantum system can “collapse”, with a certain probability, to any physically allowed state when a measurement of the system's state is performed. Since the measurement result is probabilistically determined, several measurements of the state of the same quantum system will not necessarily yield the same result. This is because, unlike a classical system—which can only exist in one of its possible states—a quantum system such as a qubit can exist in any “superposition” (i.e., combination) of the independent, physically distinguishable quantum states in which the system can be observed or measured. This superposition state contains information about each of the possible independent quantum states as well as information related to the probability of observing the quantum system in each of the possible independent states. Since a quantum superposition state contains more information than a classical state, a single qubit (which can exist in any superposition of two independent states) is capable of representing a greater amount of information than a single classical bit (which can exist in only a single state at a time). As a result, quantum computers are theorized to be capable of solving complex computational problems which classical computers are incapable of solving in practical amounts of time.

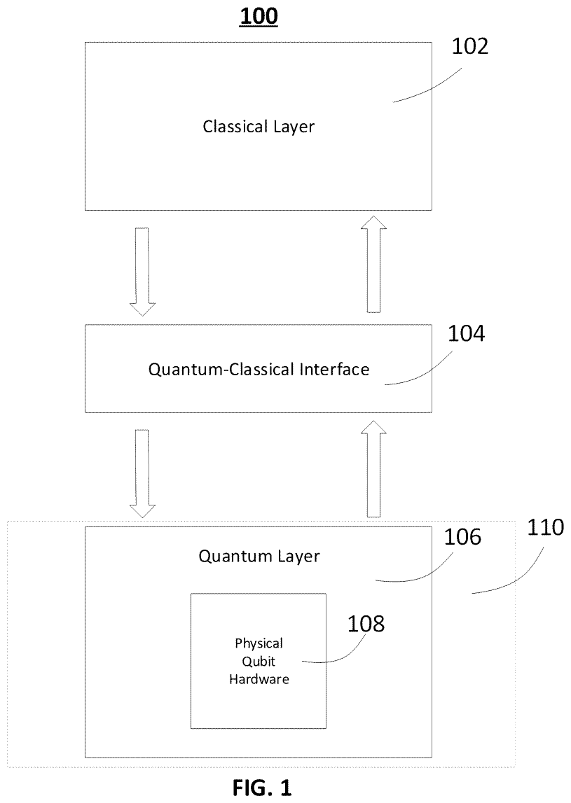

Although quantum computing systems have the potential to solve problems that classical computers cannot, quantum computing systems present various design challenges. Quantum computers store information in the quantum states of qubits; as such, the ability to accurately and precisely control the quantum states of qubits is absolutely essential to the development of scalable, functioning quantum computing systems. Quantum systems, however, are inherently fragile; as such, storing information in a quantum state for extended periods of time is difficult. Small fluctuations (e.g., thermal fluctuations) in the environment surrounding a system of qubits, for example, can disturb the state of the system and cause “decoherence”, which renders the quantum information contained in the qubit system inaccessible. One method of controlling the qubit states is to house systems of qubits in cryogenic environments (i.e., environments at temperatures below about −180° C./−292° F./93 K). Maintaining the controlled environment at cryogenic temperatures can reduce thermal fluctuations in the controlled environment, which may otherwise disturb the state of the qubit system. However, maintaining the environment at cryogenic temperatures means the any physical hardware used within the controlled environment must be capable of operating efficiently in a cryogenic environment. In addition, other mechanisms of qubit control beyond controlling the environment are needed in order to successfully perform quantum computations. These control mechanisms need to be scalable, accurate, and capable of functioning alongside one another. FIG. 1 illustrates an exemplary quantum computing system according to one or more examples of the present disclosure. As shown, the quantum computing system 100 includes a classical layer 102, a classical-quantum interface 104, and a quantum layer 106. In one or more examples, the quantum computing system 100 can be configured to perform computations by recording information during the “collapsed” state of qubits when they are being measured, extracting this information via the classical-quantum interface 104, and relaying the information to the classical layer 102 where it can be processed and analyzed.

The classical layer 102 can include traditional computing devices such as CPUs and GPUs. In one or more examples, the classical layer 102 may include one or more user interfaces configured to receive input from a user. In one or more examples, the classical layer 102 may include one or more displays. The displays may be configured to provide users with information related to computations being performed by quantum computing system 100. In one or more examples, the classical layer 102 can be configured to compile instructions for a given quantum algorithm to be executed by the quantum computing system 100. In one or more examples, the classical layer 102 can process quantum-state measurements received from the classical-quantum interface 104 after the quantum algorithm is executed. Executing the quantum algorithm can include generating a series of signals such as voltage sweeps, microwave pulses, optical pulses, etc., via a suitable device.

The quantum layer 106 can be contained in a controlled environment 110, and can include physical qubit emitters 108. In one or more examples, the controlled environment 110 can be maintained at cryogenic temperatures. For example, the controlled environment may be maintained at temperatures below about −180° C./−292° F./93 K.

In one or more examples, the physical qubit emitters 108 can be configured to generate physical implementations of qubits—i.e., configured to generate and encode information in the quantum states of a plurality of two-state quantum systems. The physical qubit emitters 108 can generate a variety of physical implementations of qubits. Such physical implementations can include, in non-limiting examples, electrons, which can occupy a superposition state that is a combination of a spin up state and a spin down state; photons, which can occupy a superposition state that is a combination of a horizontal polarization state and a vertical polarization state; and superconducting “islands” formed using Josephson junctions, which can occupy a superposition state that is a combination of an uncharged state and a charged state. In one or more examples, physical qubit emitters 108 may generate “hybrid” quantum systems which combine multiple quantum degrees of freedom—for example, a hybrid qubit formed from a coupling of an electron and a photon. As explained above, the qubit is the quantum analogue to a classical bit. Accordingly, in one or more examples, the physical qubit hardware 108 can be the quantum analog to transistors, which control bits in a classical computer.

In one or more examples, information may be transmitted between the classical layer 102 and the quantum layer 106 via a classical-quantum interface 104. For instance, a user may provide an algorithm or a problem to be solved to a computing device in the classical layer 102. The classical layer 102 can compile instructions based on the provided algorithm or problem and provide those instructions to the classical-quantum interface 104, which can then create the various kinds of signals necessary to control the qubits in the quantum layer 106 based on the instructions.

The classical-quantum interface 104 may comprise one or more classical circuits configured to perform a plurality of tasks related to controlling the states of the qubits generated in quantum hardware layer 106. Such circuits may include digital-to-analogue converters, amplifiers, which may facilitate the transmission of information between qubits, as well as field-programmable gate arrays (FPGAs) and application-specific integrated circuits (ASICs), which may be implemented in feedback systems configured to control the qubit states based on measurements of the states of the qubits. Once necessary information has been extracted from the quantum layer 106, it may be uploaded to classical layer 102 for further processing and analysis.

Qubits, as discussed above, can be represented by any two-state quantum system. Qubits can also be implemented using “hybrid” systems which employ correlations between the quantum state of one system (e.g., an electron) and the quantum state of another system (e.g., a photon). One method of generating these hybrid qubits harnesses physical properties of atom-like defects in the atomic structure of solid state hosts. As explained below, information can be encoded in the quantum states of free electrons at an atom-like defect site. When these electrons move between energy levels, they emit photons whose quantum states are correlated with the electrons' quantum states. Measuring properties (e.g., frequency, intensity, number, etc.) of these photons can provide information about the quantum states of the electrons; this information, in turn, may be used to control the quantum states of the electrons. These photons may also be routed away from the point defect site (e.g., to another component of an optoelectronic system) for further entanglement.

The present disclosure is directed to systems and methods for controlling qubits encoded in atom-like defect sites in solid state host materials. Since qubits are a fundamental component of quantum computing, the ability to accurately control qubits is essential to the development of scalable, functional quantum computers. The correspondence between the quantum states of the electrons and the quantum states of the photons emitted from atom-like defect sites in solid state hosts allows the quantum state of the photons to be controlled by controlling the quantum states of the electrons (and vice versa). Information encoded in the electrons' quantum states can thus be networked across a large system of qubits by allowing interactions between the photons emitted from different atom-like defects within the system. In order to achieve the desired interactions between photons emitted from multiple qubits, precise control over the properties of the qubits and their emitted photons is desired. The systems and methods described herein provide a means to precisely control properties of photons emitted from qubits in diamond waveguides in order to exploit the correspondence between the quantum states of emitted photons and the quantum states of electrons at atom-like defect sites.

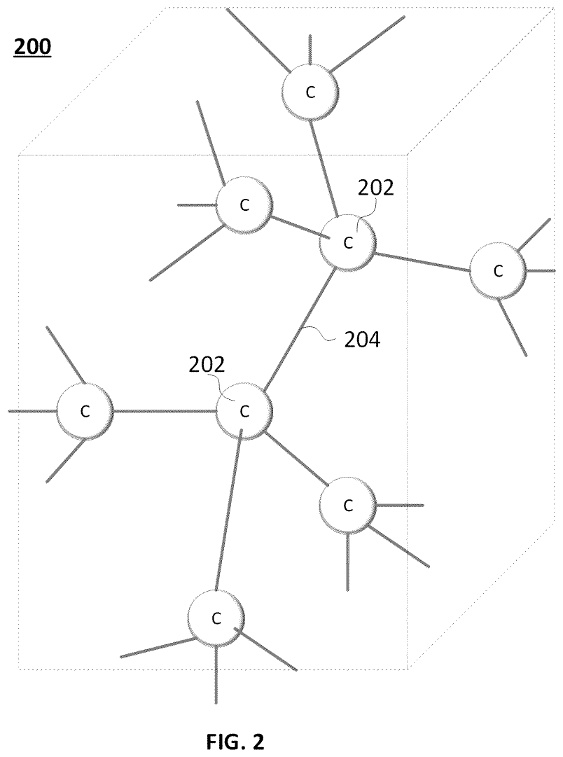

FIG. 2 illustrates an exemplary solid-state host according to examples of the disclosure. Specifically, FIG. 2 shows a diamond lattice unit 200 comprising carbon atoms 202 arranged in a crystal structure. In one or more examples, each carbon atom of carbon atoms 202 can be joined to its four nearest neighbors by covalent bonds 204 formed by shared pairs of electrons. Since a carbon atom has four valence electrons, and each carbon atom of carbon atoms 202 can be bonded to its four nearest neighbors, each valence electron of each carbon atom of carbon atoms 202 can be used in a bond 204. Therefore diamond (in theory) does not contain any free electrons.

In reality, various points in the crystal structure of diamond may have defects. Imperfections in the lattice can arise naturally while the diamond is forming or can be introduced by an external source during or after the diamond's formation. In some cases, one or more carbon atoms may be missing from the lattice. The vacancy left by the missing carbon atoms may be implanted (naturally or artificially) with a non-carbon atom. These “point defects” (also known as “color centers” due to their effect on the diamond's color) can be used to form artificial atoms which have free electrons. The free electrons can jump from a low energy ground state to a higher energy excited state upon absorption of excitation light at appropriate frequencies. After some time, the excited electrons will return to their ground states, emitting photons in the process. The quantum states of the emitted photons will be correlated with the quantum states of the electrons. Certain properties (e.g., the frequency) of the emitted photons may provide information about the quantum states of the electrons and, therefore, about any information encoded in the electrons' quantum states. As a result, these photons can be used to mediate interactions between the qubits, provided their properties can be controlled precisely.

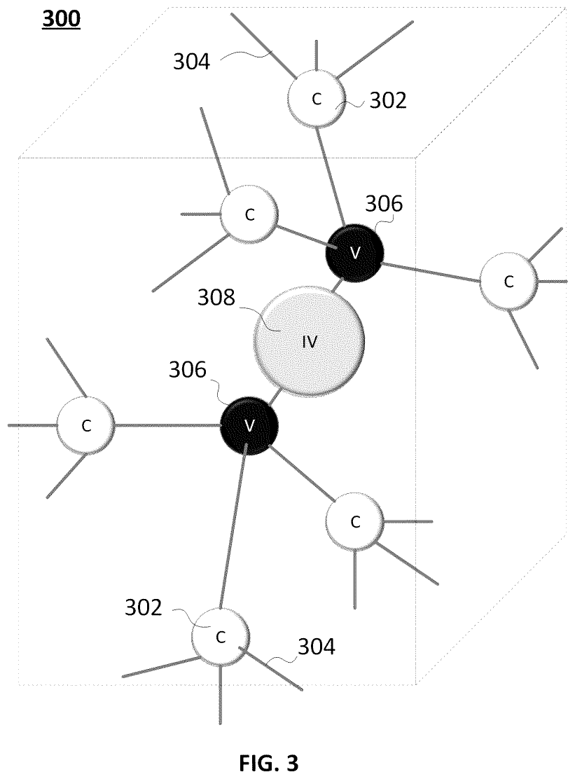

FIG. 3 illustrates an exemplary atom-like defect site in a solid-state host according to examples of the disclosure. Specifically, FIG. 3 shows a group IV defect site, a type of point defect site in diamond. Like diamond lattice unit 200 shown in FIG. 2, diamond lattice unit 300 may include a plurality of carbon atoms 302 joined by covalent bonds 304. However, unlike diamond lattice unit 200, diamond lattice unit 300 may include two vacancies 306 wherein carbon atoms are missing. A non-carbon group IV atom 308 can occupy the space between the two vacancies 306. Group IV atom 308 may be any atom from group IV of the periodic table—e.g., silicon (Si), germanium (Ge), tin (Sn), or lead (Pb). These defect sites display high optical quality in photonic nanostructures. In particular, group IV defect sites exhibit large susceptibility to strain in the diamond lattice. When strain is applied to a diamond lattice at a group IV defect site, the energy levels of the electrons at the defect site shift, causing changes in the frequencies of the photons emitted from the defect site. As such, in larger systems comprising multiple qubits encoded in a plurality of point defect sites, strain control of the photons emitted from the defect sites may enable said photons to be used to mediate interactions between the multiple qubits.

Other types of atom-like defects in solid state hosts (e.g., defects in silicon carbide) have physical properties similar to those of point defects in diamond. In particular, like point defects in diamond, atom-like defects in solid state hosts are susceptible to strain applied to the solid-state host at the defect site. Accordingly, qubits encoded in atom-like defects in solid state hosts (referred to hereafter as “solid state qubits”) may be controlled by inducing strain in the solid-state hosts.

Exemplary methods of controlling solid state qubits involve inducing strain in the solid-state host via capacitive actuation. However, methods involving capacitive actuation have several limitations, including slow tuning rates and restricted tuning ranges (e.g., limitations to single direction tuning). Discussed below are systems and methods for controlling solid state qubits by applying strain to a solid-state host at an atom-like defect site using a piezoelectric cantilever. These piezoelectric strain control methods can achieve a level of control not previously seen with capacitive actuation. Specifically, the systems and methods of the present disclosure allow for high frequency, bi-directional tuning of the frequency of photons emitted from the defect site, thus providing a high level of control over the quantum states of the encoded qubits. Note that while the exemplary implementations described hereafter describe piezoelectric control of qubits encoded in point defects in diamond, the systems and methods of the present disclosure may be adapted to control qubits encoded in any atom-like defect site that is susceptible to mechanical strain.

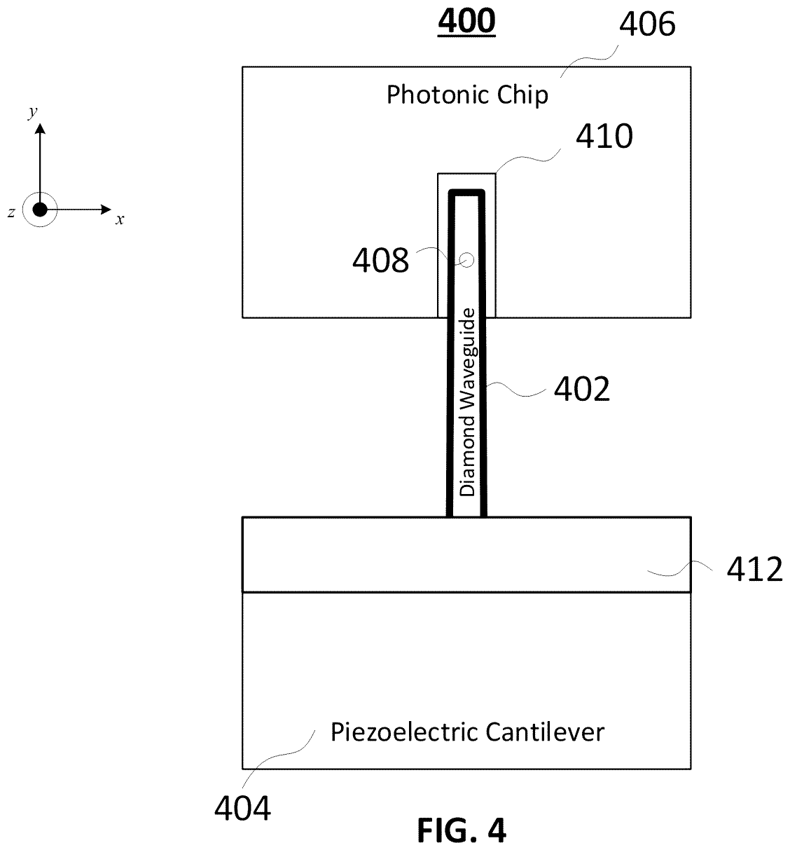

FIG. 4 illustrates a top view of a system for piezoelectric control of a qubits encoded in an atom-like defect site according to one or more examples of the present disclosure. Specifically, FIG. 4 shows a system 400 comprising a diamond waveguide 402, a piezoelectric cantilever 404, and a photonic chip 406. In one or more examples, system 400 may be a component of a larger optoelectronic system such as a quantum computing system (e.g., quantum computing system 100 shown in FIG. 1). In one or more examples, system 400 may be configured to operate in cryogenic environments.

Diamond waveguide 402 may comprise group IV defect site 408. In one or more examples, a qubit may be encoded in group IV defect site 408. In one or more examples, group IV defect site 408 may be a tin defect site (SnV), a silicon defect site (SiV), a germanium defect site (GeV), or a lead defect site (PbV). In one or more examples, manufacture of group IV defect site 408 may comprise ion implantation processes—i.e., group IV defect site 408 may be formed by accelerating group IV ions (e.g., tin, silicon, germanium, or lead ions) into diamond waveguide 402 in order to implant the group IV ions in the diamond lattice. In one or more examples, manufacture of group IV defect site 408 may comprise implanting a group IV ion in a diamond substrate and then fabricating diamond waveguide 402 around the subsequently formed group IV defect site 408. In one or more examples, group IV defect site 408 may be randomly positioned along diamond waveguide 402.

In one or more examples, excitation light may be transmitted to group IV defect site 408 in order to cause group IV defect site 408 to emit a photon. The excitation light may be provided by a laser. The excitation light may be chosen based on the type of group IV defect (i.e., based on the group IV atom that is implanted in the diamond lattice). In one or more examples, the excitation light may comprise light having a wavelength less than or equal to 700 nm, 600 nm, 500 nm, 500 nm, 400 nm, or 300 nm. In one or more examples, the excitation light may comprise light having a wavelength greater than or equal to 700 nm, 600 nm, 500 nm, 500 nm, 400 nm, or 300 nm. In one or more examples, the excitation light may comprise light having a wavelength between 200-300 nm, 300-400 nm, 400-500 nm, 500-500 nm, 500-600 nm, 600-700 nm, or 700-800 nm.

After receiving excitation light, group IV defect site 408 may emit a photon. Diamond waveguide 408 may be optically coupled to photonic chip 406 and may be configured to transmit photons emitted from group IV defect site 408 to photonic chip 406. Photonic chip 406, in turn, may comprise one or more waveguides or other optical devices configured to perform operations on the received photons. In one or more examples, photonic chip 406 may comprise a socket 410 into which diamond waveguide 402 may be integrated in order to facilitate optical coupling between diamond waveguide 402 and photonic chip 406.

In one or more examples, the frequency of a photon emitted by group IV defect site 408 may be measured. The frequency of the photon may correspond to the quantum state of the defect site electron which emitted the photon. Measuring the frequency of the photon may, therefore, provide information about the quantum state of the electron. Based on this information, group IV defect site 408 may be tuned by applying strain to the diamond lattice of diamond waveguide 402 at group IV defect site 408. For example, if the frequency of the emitted photon is higher than a desired frequency, strain may be applied at group IV defect site 408 in order to decrease the frequency of subsequently emitted photons.

In one or more examples, piezoelectric cantilever 404 may be configured to apply strain to the diamond lattice of diamond waveguide 402 at group IV defect site 408. A portion of piezoelectric cantilever 404 may be configured to deflect away from an equilibrium position of piezoelectric cantilever 404 in response to an electrical signal applied to it. Diamond waveguide 402 may be mechanically coupled to said portion of piezoelectric cantilever 404 such that, when the portion is displaced from the equilibrium position, diamond waveguide 402 mechanically deforms. As diamond waveguide 402 deforms, strain may be induced in the diamond lattice of diamond waveguide 402 at group IV defect site 408, causing the energy levels of group IV defect site to shift.

In order to facilitate mechanical coupling between diamond waveguide 402 and piezoelectric cantilever 404, a binding layer 412 may be applied over an overlapping portion of diamond waveguide 402 and piezoelectric cantilever 404. Binding layer 412 may comprise any material which does not adversely affect the properties of group IV defect 408 or interfere with light propagation in diamond waveguide 402. In one or more examples, binding layer 412 may comprise aluminum oxide. In one or more examples, binding layer 412 may be less than or equal to 100, 75, 50, 25, 10, or 5 nm thick. In one or more examples, binding layer 412 may be greater than or equal to 0.1, 1, 5, 10, 25, 50, or 75 nm thick.

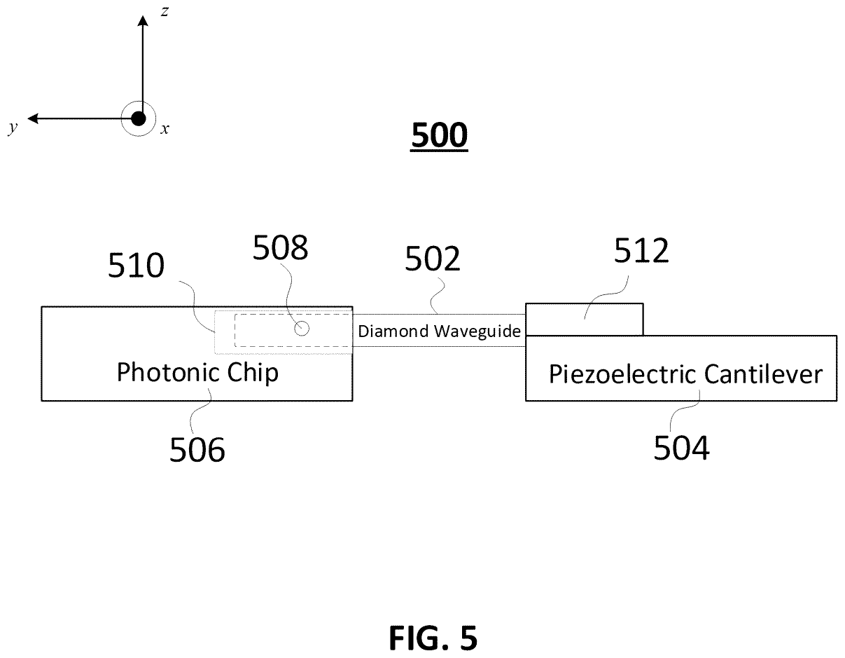

FIG. 5 illustrates a side view of an exemplary system for piezoelectric control of a qubits encoded in atom-like defect sites according to one or more examples of the present disclosure. Specifically, FIG. 5 shows a system 500 comprising a diamond waveguide 502, a piezoelectric cantilever 504, and a photonic chip 506. In one or more examples, system 500 may be a component of a larger optoelectronic system such as a quantum computing system (e.g., quantum computing system 100 shown in FIG. 1). System 500 may be similar to or identical to system 400 shown in FIG. 4. In one or more examples, system 500 may be configured to operate in cryogenic environments.

Diamond waveguide 502 may include a group IV defect site 508. Like diamond waveguide 402 shown in FIG. 4, diamond waveguide 502 may be configured to optically couple to photonic chip 506. Photonic chip 506 may comprise one or more waveguides or other optical components configured to receive and perform operations on photons emitted by group IV defect site 508. In one or more examples, diamond waveguide 502 may be configured to be integrated into a socket 510 in photonic chip 506 in order to facilitate optical coupling between diamond waveguide 502 and photonic chip 506.

Piezoelectric cantilever 504 may be configured to control the frequencies of photons emitted by group IV defect site 508 by straining the diamond lattice of diamond waveguide 502 at group IV defect site 508. In one or more examples, piezoelectric cantilever 504 may be configured to apply strain to the diamond lattice of diamond waveguide 502 by displacing in one or more directions. FIG. 5 shows system 500 as aligned along the plane formed by the direction labeled x and the direction labeled y. In one or more examples, piezoelectric cantilever 504 may be configured to deflect in a direction perpendicular to this xy-plane when a voltage is applied—i.e., when a voltage is applied, piezoelectric cantilever 504 may be configured to deflect in the +z and/or the −z directions.

Diamond waveguide 502 may be mechanically coupled to piezoelectric cantilever 504 such that any displacement of piezoelectric cantilever 504 causes diamond waveguide 502 to deform. In one or more examples, the position of photonic chip 506 (and, therefore, socket 512 into which a portion of diamond waveguide 502 may be integrated) may be fixed; as a result, only a portion of diamond waveguide that is mechanically coupled to piezoelectric cantilever 504 may be free to move. In one or more examples, a binding layer 512 may be deposited over an overlapping portion of diamond waveguide 502 and piezoelectric cantilever 504 in order to facilitate mechanical coupling between diamond waveguide 502 and piezoelectric cantilever 504. Deformations in diamond waveguide 502 may induce strain on the diamond lattice at group IV defect site 508. This strain, in turn, may perturb the energy levels of electrons at group IV defect site 508, thereby changing the frequency of photons emitted by group IV defect site 508 when the electrons transition between energy levels. Accordingly, displacing piezoelectric cantilever 504 may allow for control of the quantum states of qubits generated by group IV defect site 508.

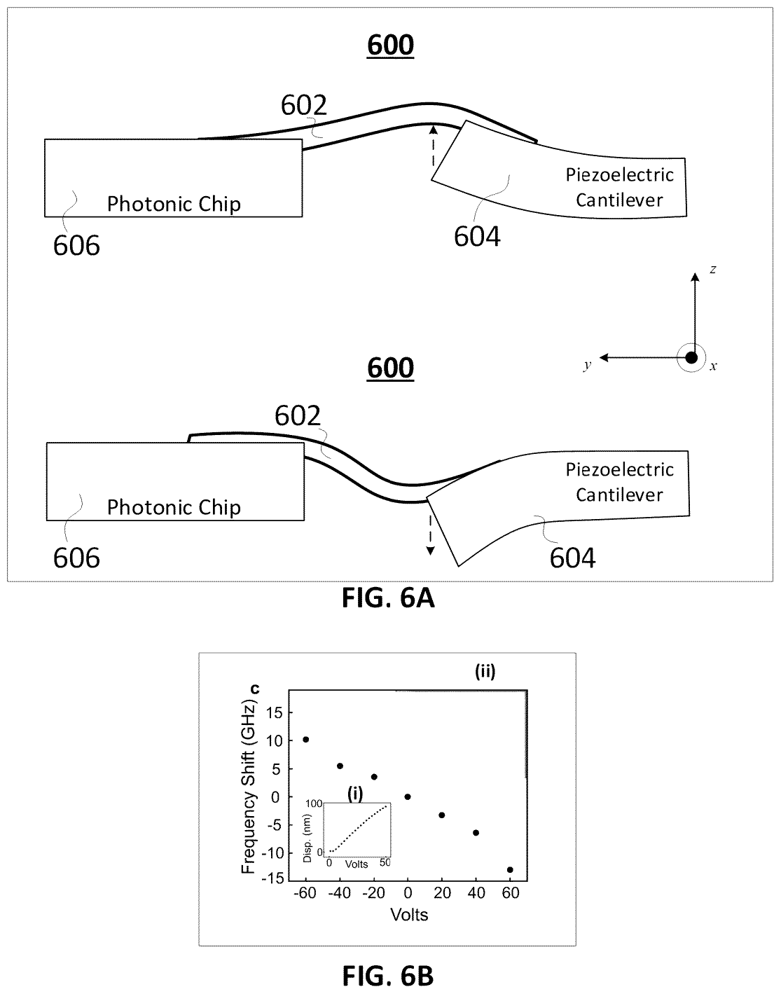

FIG. 6A illustrates potential deformations of a diamond waveguide caused by deflections of a piezoelectric cantilever according to one or more examples of the present disclosure. Specifically, FIG. 6A shows side views of a system 600 comprising a diamond waveguide 602 positioned between a piezoelectric cantilever 604 and a photonic chip 606. System 600 may be identical to or include features of system 500 shown in FIG. 5 and/or system 400 shown in FIG. 4. As shown, system 600 may be aligned along a plane, for example the plane formed by the direction labeled x and the direction labeled y. In one or more examples, this plane may correspond to a substrate upon which system 600 is fixed. In one or more examples, piezoelectric cantilever 604 may be in an equilibrium position whenever it is aligned with this plane. When piezoelectric cantilever 604 is in this equilibrium position, it may not be applying strain to diamond waveguide 602.

In one or more examples, the position of photonic chip 606 may be fixed, while (a portion of) piezoelectric cantilever 604 may be configured to deflect in a direction perpendicular to the xy-plane along which system 600 is aligned (e.g., the +z and/or the −z directions). This deflection may occur when a voltage is applied to piezoelectric cantilever 604. In one or more examples, one end of diamond waveguide 602 may be mechanically coupled to piezoelectric cantilever 604 such that, when piezoelectric cantilever 604 is caused to displace, diamond waveguide 602 is caused to deform. This deformation may induce a strain on the diamond lattice of diamond waveguide 602 at the site of a group IV defect, thereby changing the frequency of photons emitted from the defect site.

The magnitude of the displacement of piezoelectric cantilever 604 away from an equilibrium position may depend on the amount of voltage applied to piezoelectric cantilever 604. In one or more examples, the magnitude of the displacement of piezoelectric cantilever 604 may be proportional to the amount of voltage applied to piezoelectric cantilever 604. In one or more examples, piezoelectric cantilever 604 may be configured to be displaced between 0-2, 0-4, 0-6, 0-8, or 0-10 nm per volt applied to piezoelectric cantilever 604. In one or more examples, a maximum displacement of piezoelectric cantilever 504 may be greater than or equal to 50, 75, 100, 125, 150, 200, or 500 nm. In one or more examples, a maximum displacement of piezoelectric cantilever 504 may be less than or equal to 1000, 600, 500, 200, 150, 125, or 100 nm. A greater maximum displacement may provide broader control over the quantum states of qubits emitted by group IV defect site 508.

The direction of frequency shift induced on the photons emitted by the group IV defect site in diamond waveguide 602 may depend on the displacement of piezoelectric cantilever 604 and, therefore, on the amount of voltage applied to piezoelectric cantilever 604 in order to cause the displacement. In one or more examples, applying a positive voltage to piezoelectric cantilever 604 may cause a positive shift in the frequency of the photons emitted by a group IV defect site. In one or more examples, applying a negative voltage to piezoelectric cantilever 604 may cause a negative shift in the frequency of the photons emitted by a group IV defect site. In one or more examples, applying a positive voltage to piezoelectric cantilever 604 may cause a negative shift in the frequency of the photons emitted by a group IV defect site. In one or more examples, applying a negative voltage to piezoelectric cantilever 604 may cause a positive shift in the frequency of the photons emitted by a group IV defect site. In one or more examples, piezoelectric cantilever 604 may be configured to cause a frequency shift of greater than or equal to 5, 10, 15, 20, 25, or 30 GHz.

FIG. 6B illustrates data showing relationships between an amount of voltage applied to a piezoelectric cantilever, the magnitude of the displacement of the piezoelectric cantilever from its equilibrium position, and the amount of shift in the frequency of the photons emitted by a group IV defect site in the diamond waveguide being deformed by the piezoelectric cantilever. The system for which the data shown in FIG. 6B was collected comprises an aluminum nitride (AlN)-based piezoelectric cantilever mechanically coupled to a diamond waveguide which includes a tin vacancy center (SnV). This system, along with the data shown in FIG. 6B, is presented for illustrative purposes and should not be construed as limiting to the present disclosure.

FIG. 6B (i) shows that increasing the voltage applied to the piezoelectric cantilever may cause the magnitude of the displacement of the piezoelectric cantilever from its equilibrium position to increase, as well. Specifically, FIG. 6B (i) shows that the piezoelectric cantilever displaces by approximately 2 nm per volt applied. Hence over a range of about 50 V the piezoelectric cantilever can be displaced from equilibrium by about 100 nm. FIG. 6B (ii) shows that, using the piezoelectric cantilever, the frequency of the photons emitted by the group IV defect site can be bi-directionally tuned. Specifically, applying voltages between 0-60 V may cause negative shifts of up to −15 GHz in the frequencies of the emitted photons, while applying voltages between −60-0 V may cause positive shifts of up to about 10 GHz in the frequencies of the emitted photons. Piezoelectric cantilevers can, therefore, be used for bi-directional frequency tuning over a broad range of the group IV defect sites, enabling extensive control of the qubits emitted by the defect site.

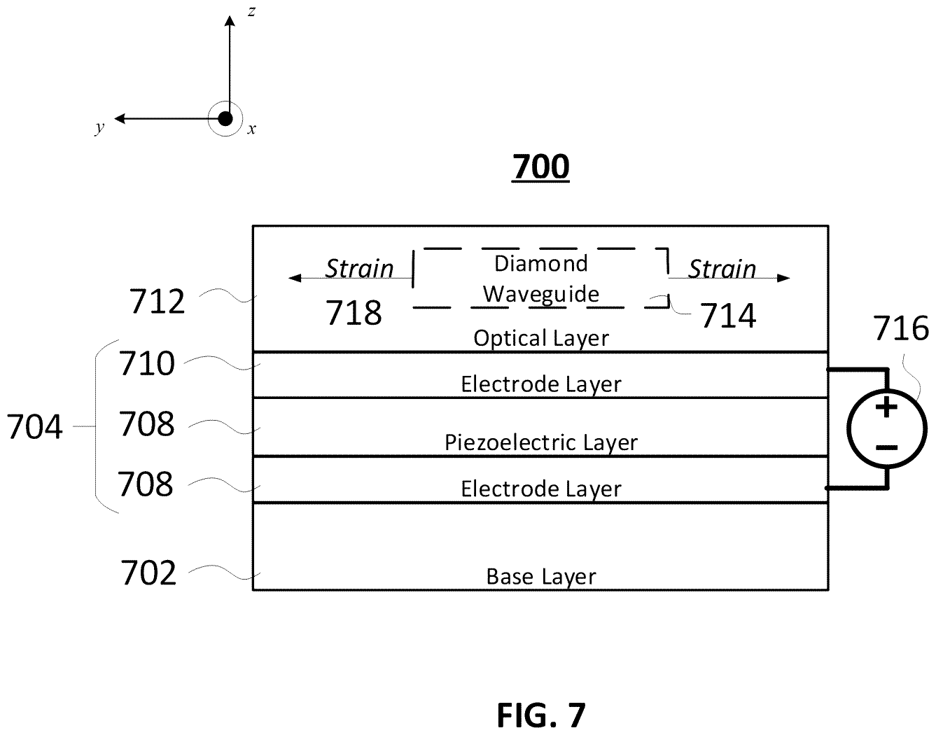

FIG. 7 illustrates a cross-section of a piezoelectric cantilever according to one or more examples of the present disclosure. Specifically, FIG. 7 illustrates a side view cross-section of a piezoelectric cantilever system 700 comprising multiple layers: a base layer 702; a piezoelectric cantilever 704 comprising a first electrode layer 706, a piezoelectric layer 708, and a second electrode layer 710; and an optical layer 712. Piezoelectric cantilever system 700 may be configured to electrically couple to a DC power source 716. In one or more examples, system 400 shown in FIG. 4, system 500 shown in FIG. 5, and/or system 600 shown in FIG. 6 may include one or more features of piezoelectric cantilever system 700. Piezoelectric cantilever system 700 may be configured to operate in a cryogenic environment.

As shown, base layer 702 may be positioned below piezoelectric cantilever 704 and/or optical layer 710. In one or more examples, base layer 702 may comprise silicon dioxide. In one or more examples, base layer 702 may comprise a sacrificial layer added during fabrication of piezoelectric cantilever 700 and configured to be removed in order to create a gap between piezoelectric cantilever 704 and another surface (e.g., another component of a quantum computing system). This gap may provide the space necessary for piezoelectric cantilever to deflect downward (i.e., in the −z direction labeled in FIG. 7). In one or more examples, base layer 702 may be between about 150 nm and about 250 nm thick. In one or more examples, base layer 702 may be less than or equal to 150 nm thick. In one or more examples, base layer 702 may be greater than or equal to 250 nm thick.

Piezoelectric cantilever 704 may be disposed atop base layer 702. In particular, in one or more examples, first electrode layer 706 may be positioned atop base layer 702 and below piezoelectric layer 708, second electrode layer 710, and/or optical layer 712. First electrode layer 706 may be an electrical conductor. In one or more examples, first electrode layer 706 may be an anode or a cathode. First electrode layer 706 may comprise materials compatible with complementary metal oxide semiconductor (CMOS) platforms and/or compatible with materials used to form piezoelectric layer 708. In one or more examples, first electrode layer 706 may comprise aluminum. In one or more examples, first electrode layer 706 may be between about 150 nm and about 250 nm thick. In one or more examples, first electrode layer 706 may be less than or equal to 150 nm thick. In one or more examples, first electrode layer 706 may be greater than or equal to 250 nm thick.

In one or more examples, piezoelectric layer 708 may be positioned atop base layer 702 and/or first electrode layer 706 and below second electrode layer 710 and/or optical layer 712. Generation of an electric field inside piezoelectric layer 708 may cause piezoelectric layer 708 to mechanically deform. This mechanical deformation may cause piezoelectric cantilever 708 to deflect away from an equilibrium position (e.g., with reference to FIG. 6, deflect in the ±z directions away from the xy-plane along which system 600 is aligned). Piezoelectric layer 708 may comprise piezoelectric material(s) that are compatible with CMOS technologies and/or that maintain necessary piezoelectric properties at cryogenic temperatures. In one or more examples, piezoelectric layer 708 may comprise aluminum nitride. In one or more examples, piezoelectric cantilever 706 may be between about 400 nm and about 500 nm thick. In one or more examples, piezoelectric cantilever 706 may be less than or equal to 400 nm thick. In one or more examples, piezoelectric cantilever 706 may be greater than or equal to 500 nm thick.

In one or more examples, second electrode layer 710 may be positioned atop base layer 702, first electrode layer 706, and/or piezoelectric layer 708 and below optical layer 712. Second electrode layer 710 may be an electrical conductor. In one or more examples, second electrode layer 710 may be an anode or a cathode. Second electrode layer 710 may comprise materials compatible with complementary metal oxide semiconductor (CMOS) platforms and/or compatible with materials used to form piezoelectric layer 708. In one or more examples, second electrode layer 710 may comprise aluminum. In one or more examples, second electrode layer 710 may be between about 150 nm and about 250 nm thick. In one or more examples, second electrode layer 710 may be less than or equal to 150 nm thick. In one or more examples, second electrode layer 710 may be greater than or equal to 250 nm thick.

Optical layer 712 may be disposed atop piezoelectric cantilever 704 and/or base layer 702. In particular, in one or more examples, optical layer 712 may be positioned atop base layer 702, first electrode layer 706, piezoelectric layer 708, and/or second electrode layer 710. Optical layer 712 may comprise a cladding layer and may comprise a portion of a diamond waveguide 714 surrounded by a binding layer 718. Diamond waveguide 714 may comprise a group IV defect site and may be configured to function as a quantum emitter (see discussion of FIGS. 4-6 for a detailed description of such quantum emitters). Binding layer 718 may be configured to facilitate mechanical coupling between diamond waveguide 714 and piezoelectric cantilever 704. In one or more examples, binding layer 718 may comprise aluminum oxide. Binding layer 718 may be between 0-10, 10-20, 20-30, 30-40, or 40-50 nm thick.

In one or more examples, DC power source 716 may comprise one or more batteries or an AC/DC power supply. DC power source 716 may be configured generate a voltage across piezoelectric cantilever 704 in order to create an electric field inside piezoelectric layer 708, thereby causing piezoelectric layer 708 to mechanically deform. In one or more examples, generating a voltage across piezoelectric cantilever 704 using DC power source 716 may comprise connecting (i.e., electrically coupling) a first terminal of DC power source 716 to first electrode layer 706 and a second terminal of DC power source 716 to second electrode layer 710. In one or more examples, the first terminal may be negatively charged and the second terminal may be positively charged (or vice versa). Connecting the first and second terminals of DC power source 716 to first electrode 706 and second electrode 710, respectively, may cause charge to build up on first electrode 706 and an opposite charge to build up on second electrode 710. This build-up of opposing charges may create an electric field within piezoelectric layer 708. In one or more examples, the strength of the electric field that is created within piezoelectric layer 708 may depend on the voltage supplied by DC power source 716. The degree and direction of the mechanical deformation of piezoelectric layer 708 may, in turn, depend on the strength of the electric field created within piezoelectric layer 708.

In response to the mechanical deformation induced in piezoelectric layer 708, piezoelectric cantilever 704 may deflect away from an equilibrium position. For example, piezoelectric cantilever 704 may be caused to deflect in the ±z directions away from the xy-plane. Mechanical coupling between piezoelectric cantilever 704 and diamond waveguide 714 may cause diamond waveguide 714 to deform when piezoelectric cantilever 704 deflects away from an equilibrium position (see FIG. 6A). In one or more examples, the deformation of diamond waveguide 714 may apply strain to the diamond lattice of diamond waveguide 714 at a group IV defect site, causing the energy levels of electrons at the group IV defect site to shift and the frequencies of photons emitted from the defect site to change.

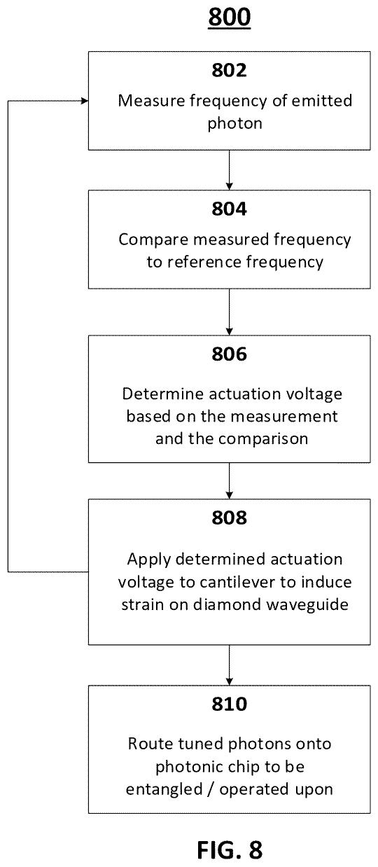

Due to the correlation between the quantum states of group IV defect site electrons and the quantum states of emitted photons, qubits generated by group IV defect sits may be controlled by controlling the frequencies of the emitted photons (e.g., by applying strain to the diamond lattice using a piezoelectric cantilever). FIG. 8 illustrates a method for piezoelectric control of a qubit encoded in an atom-like defect site according to one or more examples of the present disclosure. Specifically, FIG. 8 shows a method 800 for tuning the frequencies of photons emitted by a group IV defect site in a diamond waveguide using a piezoelectric cantilever.

In one or more examples, method 800 may be implemented in an optoelectronic system such as quantum computing system 100 shown in FIG. 1. One or more steps of method 800 may be executed by components of a classical layer of a quantum computing system and/or by components of a quantum layer of a quantum computing system. In particular, one or more steps of method 800 may be performed by a system for piezoelectric control of a quantum emitter such as system 400 shown in FIG. 4, system 500 shown in FIG. 5, or system 600 shown in FIG. 6. The piezoelectric cantilever system discussed below with respect to method 900 may include one or more components of a piezoelectric cantilever system such as piezoelectric cantilever system 700 shown in FIG. 7.

In one or more examples, method 800 may begin after a group IV defect site has been excited with excitation light and has subsequently emitted a photon. The group IV defect site may be implanted within a diamond waveguide which is mechanically coupled to a piezoelectric cantilever. At step 802, the frequency of the emitted photon may be measured. In one or more examples, the photon's frequency may be measured using one or more sensors (e.g., a signal processor). In one or more examples, step 802 may be performed automatically or may be performed upon receiving instructions from a user.

After the frequency of the emitted photon is measured in step 802, method 800 may proceed to step 804, wherein the measured frequency may be compared to a reference frequency. In one or more examples, the reference frequency may be empirically determined. In one or more examples, the reference frequency may be determined by measuring the frequencies of photons emitted from other group IV defect sites within the same optoelectronic system. Comparing the measured frequency to the reference frequency may involve determining one or more differences between the measured frequency and the reference frequency. These differences may provide information about how the quantum emitter should be tuned in order to cause the qubits to occupy a desired quantum state.

Once the measured frequency of the emitted photon has been compared to the reference frequency in step 804, method 800 may proceed to step 806, wherein an appropriate actuation voltage may be determined based on the measured frequency and/or the results of the comparison between the measured frequency and the reference frequency. The actuation voltage may be a voltage to be applied to the piezoelectric cantilever in order to cause the piezoelectric cantilever to deflect away from an equilibrium position. The actuation voltage may be correlated with a displacement (i.e., a magnitude and direction of deflection) of the piezoelectric cantilever. This displacement may, in turn, be correlated with an amount of strain which may be induced in the diamond lattice at the group IV defect site if the actuation voltage is applied to the piezoelectric cantilever. Said amount of strain, if induced, may cause a shift in the energy levels of the group IV defect site, thereby changing the frequencies of subsequently emitted photons. In one or more examples, this change may be necessary in order to cause the group IV defect site to emit photons with frequencies equal to (or nearly equal to) the reference frequency.

In one or more examples, after the actuation voltage has been determined in step 806, method 800 may proceed to step 808, wherein the actuation voltage may be applied to the piezoelectric cantilever in order to induce strain in the diamond lattice at the group IV defect site. The piezoelectric cantilever may comprise a layer of piezoelectric material positioned between two electrodes (see, for example, piezoelectric cantilever 704 shown in FIG. 7). In one or more examples, applying the actuation voltage to the piezoelectric cantilever may comprise connecting a DC power source to the two electrode layers. This may cause a build-up of opposing charges on the electrode layers, which may create an electric field within the piezoelectric layer. The created electric field may cause the piezoelectric layer to mechanically deform. As a result of the mechanical deformation of the piezoelectric layer, the piezoelectric cantilever may deflect away from its equilibrium position, causing the diamond waveguide to deform. The deformation of the diamond waveguide may induce strain in the diamond lattice at the group IV defect site.

In one or more examples, after the actuation voltage has been applied to the piezoelectric cantilever in step 808, method 800 may return to step 802, wherein the frequency of a photon emitted after strain has been applied to the group IV defect site may be measured. Method 800 may cycle through steps 802-808 as necessary until the group IV defect site emits photons of a desired frequency (e.g., until the group IV defect site emits photons with frequencies equal to the reference frequency). In one or more examples, once the group IV defect site has been appropriately tuned and is emitting photons of a desired frequency, method 800 may proceed to step 810, wherein the tuned photons may be routed onto a photonic chip (e.g., photonic chip 406 shown in FIG. 4) to be entangled with other photons and/or to be operated upon in a different stage of a quantum computation.

Just as classical computers require a plurality of bits, quantum computers require a plurality of qubits. The systems and methods for piezoelectric control of a group IV defect site in a diamond waveguide may be scaled to systems comprising multiple quantum emitters. As such, the systems and methods of the present disclosure may be implemented in functional quantum computing systems in order to control the qubits used to store information.

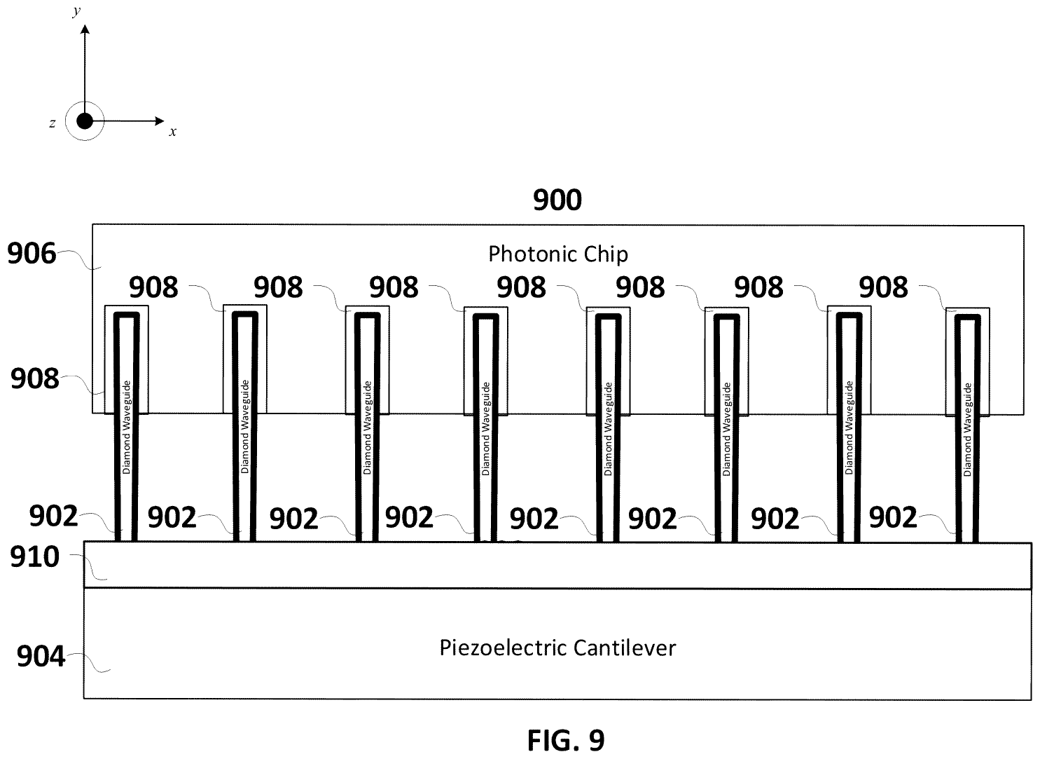

FIG. 9 illustrates a system for piezoelectric control of a plurality of qubits encoded in a plurality of atom-like defect sites according to one or more examples of the present disclosure. Specifically, FIG. 9 shows a system 900 comprising an array of diamond waveguides 902 positioned between a piezoelectric cantilever 904 and a photonic chip 906. In one or more examples, the array of diamond waveguides 902 may form a quantum microchiplet (QMC). The array of diamond waveguides 902 may comprise between 1-5, 5-10, 10-15, 15-20, or 20-25 diamond waveguides. In one or more examples, the array of diamond waveguides 902 may comprise greater than or equal to 25, 30, 35, or 40 diamond waveguides.

Each diamond waveguide 902 may comprise a group IV defect. Each diamond waveguide 902 may be optically coupled to photonic chip 906. In one or more examples, photonic chip 906 may be configured to receive photons emitted by group IV defects in diamond waveguides 902. In one or more examples, diamond waveguides 902 may be configured to be integrated into sockets 908 in photonic chip 906 in order to facilitate optical coupling between diamond waveguides 902 and photonic chip 906.

In one or more examples, each diamond waveguide 902 may be mechanically coupled to piezoelectric cantilever 904. Piezoelectric cantilever 904 may include features of piezoelectric cantilever 400 shown in FIG. 4, piezoelectric cantilever 500 shown in FIG. 5, piezoelectric cantilever 600 shown in FIG. 6, and/or piezoelectric cantilever 704 shown in FIG. 7. When an appropriate actuation voltage is applied to piezoelectric cantilever 904, a portion of piezoelectric cantilever 904 may be configured to deflect away from an equilibrium position. Each diamond waveguide 902 may deform as a result of said deflection due to the mechanical coupling between the diamond waveguides 902 and piezoelectric cantilever 904. The deformation of each diamond waveguide 902 may cause the frequencies of photons emitted by each diamond waveguide 902 to shift. Since each diamond waveguide 902 is coupled to the same piezoelectric cantilever 904, the group IV defect sites in each diamond waveguide 902 may be simultaneously and identically tuned. In one or more examples, a binding layer 910 may be deposited atop an overlapping portion of diamond waveguides 902 and piezoelectric cantilever 904 in order to facilitate the mechanical coupling.

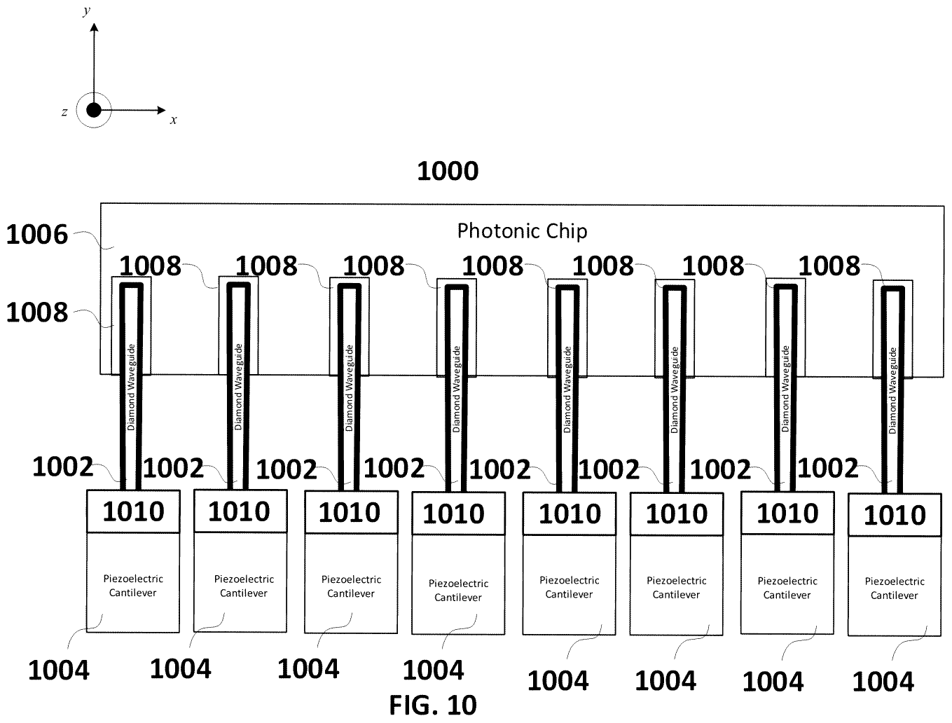

FIG. 10 illustrates an exemplary alternative system for piezoelectric control of a plurality of qubits encoded in a plurality of atom-like defect sites according to one or more examples of the present disclosure. Specifically, FIG. 10 shows a system 1000 comprising an array of diamond waveguides 1002, each of which is connected to a separate piezoelectric cantilever 1004. In one or more examples, the array of diamond waveguides 1002 may form a quantum micro-chiplet (QMC). The array of diamond waveguides 1002 may comprise between 1-5, 5-10, 10-15, 15-20, or 20-25 diamond waveguides. In one or more examples, the array of diamond waveguides 1002 may comprise greater than or equal to 25, 30, 35, or 40 diamond waveguides.

Each diamond waveguide 1002 may comprise a group IV defect. Each diamond waveguide 1002 may be optically coupled to a single photonic chip 1006. In one or more examples, photonic chip 1006 may be configured to receive photons emitted by group IV defects in diamond waveguides 1002. In one or more examples, diamond waveguides 1002 may be configured to be integrated into sockets 1008 in photonic chip 1006 in order to facilitate optical coupling between diamond waveguides 1002 and photonic chip 1006.

In one or more examples, each diamond waveguide 1002 may be mechanically coupled to a distinct piezoelectric cantilever 1004. Each piezoelectric cantilever 1004 may include features of piezoelectric cantilever 400 shown in FIG. 4, piezoelectric cantilever 500 shown in FIG. 5, piezoelectric cantilever 600 shown in FIG. 6, and/or piezoelectric cantilever 704 shown in FIG. 7. When an appropriate actuation voltage is applied to a piezoelectric cantilever 1004, a portion of that piezoelectric cantilever 1004 may be configured to deflect away from an equilibrium position. The diamond waveguide 1002 which is coupled to that piezoelectric cantilever 1004 may deform as a result of said deflection. The deformation of the diamond waveguide 1002 may cause the frequencies of photons emitted by that diamond waveguide 1002 to shift. Since each diamond waveguide 1002 is coupled to a different piezoelectric cantilever 1004, the group IV defect sites in each diamond waveguide 1002 are individually tuned. In one or more examples, a binding layer 1010 may be deposited atop an overlapping portion of each diamond waveguides 1002 and the corresponding piezoelectric cantilever 1004 in order to facilitate the mechanical coupling.

In the systems and methods discussed thus far, a DC signal is applied to a piezoelectric cantilever in order to control a group IV defect site. In one or more examples, an AC signal, rather than a DC signal, may be applied to piezoelectric cantilevers described herein. As the current applied to the cantilever oscillates, the degree of deflection of the cantilever may change, thereby changing the frequency of photons emitted from the group IV defect site.

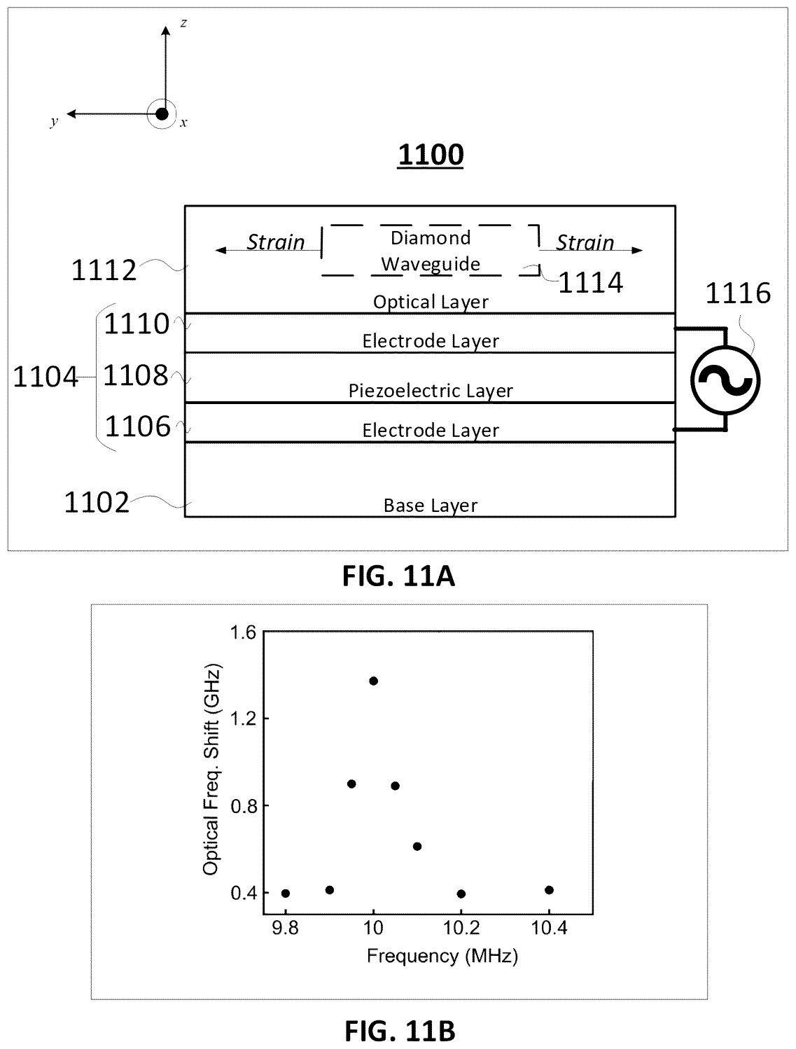

FIG. 11A illustrates a piezoelectric cantilever system driven by an AC signal according to one or more examples of the present disclosure. Specifically, FIG. 11A shows a piezoelectric cantilever system 1100 comprising a base layer 1102, a piezoelectric cantilever 1104, and an optical layer 1112. In one or more examples, base layer 1102, piezoelectric cantilever 1104, and/or optical layer 1112 may include one or more features of base layer 702, piezoelectric cantilever 704, and/or optical layer 712 shown in FIG. 7. In particular, piezoelectric cantilever 1104 may comprise a first electrode layer 1106, a piezoelectric layer 1108, and a second electrode layer 1110. Optical layer 1112 may comprise a diamond waveguide 1114. In one or more examples, first electrode layer 1106 and second electrode layer 1110 may be configured to respectively connect to a first terminal and a second terminal of an AC power source 1116. In one or more examples, driving piezoelectric cantilever 1104 using an AC signal with a frequency that corresponds to a mechanical resonance of piezoelectric cantilever 1104 may result in larger shifts in the frequencies of emitted photons than could be accomplished using a DC signal.

FIG. 11B illustrates data showing a relationship between a driving frequency of a piezoelectric cantilever and a magnitude of a frequency shift induced on photons emitted from a group IV defect site. As shown, the frequency shift induced on the emitted photons is significantly increased when the piezoelectric cantilever is driven at a frequency of approximately 10 MHz. In one or more examples, the maximal frequency shift may occur when the piezoelectric cantilever is driven near a mechanical resonance.

Example—Piezoelectric control of tin vacancy (SnV) defects

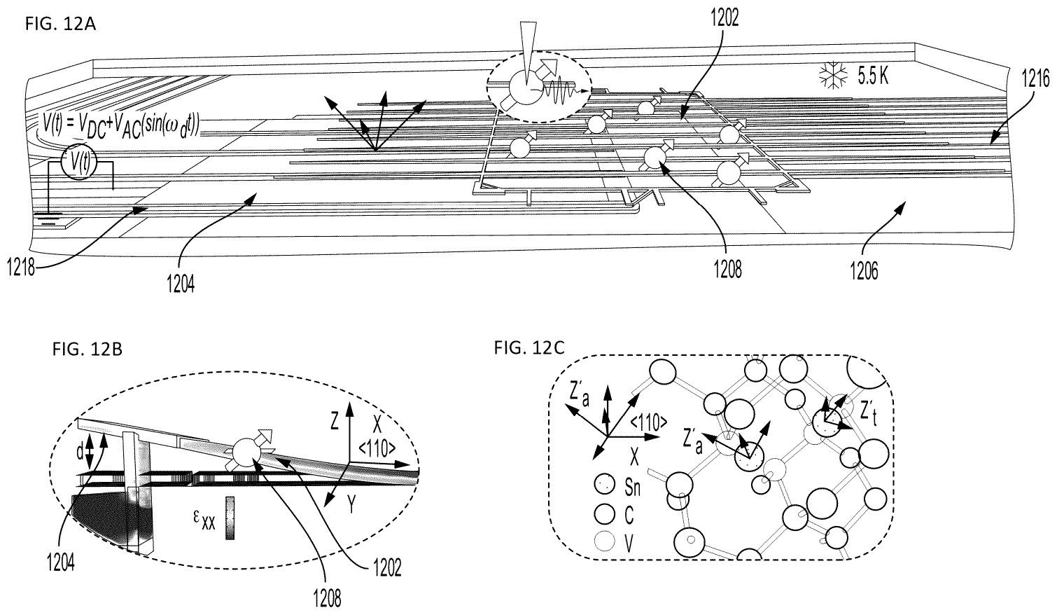

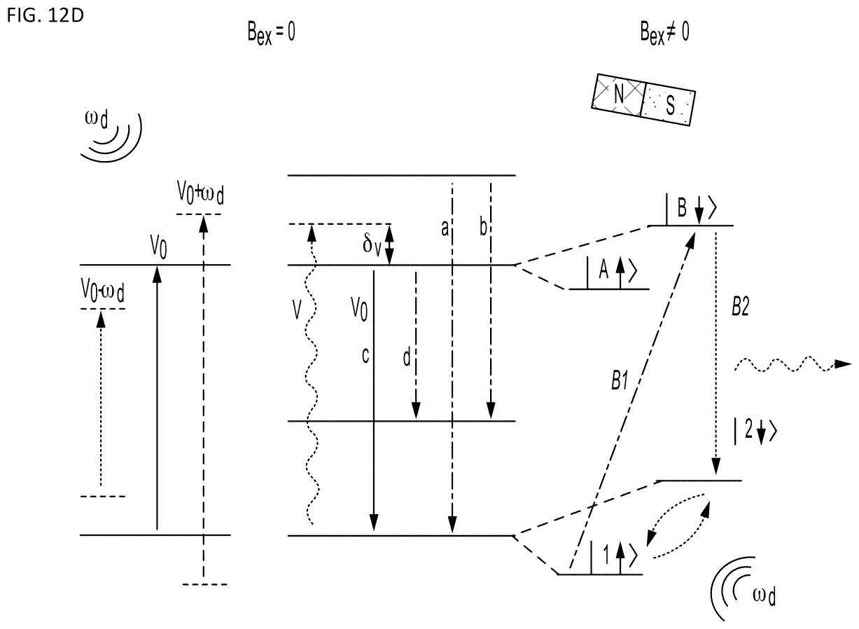

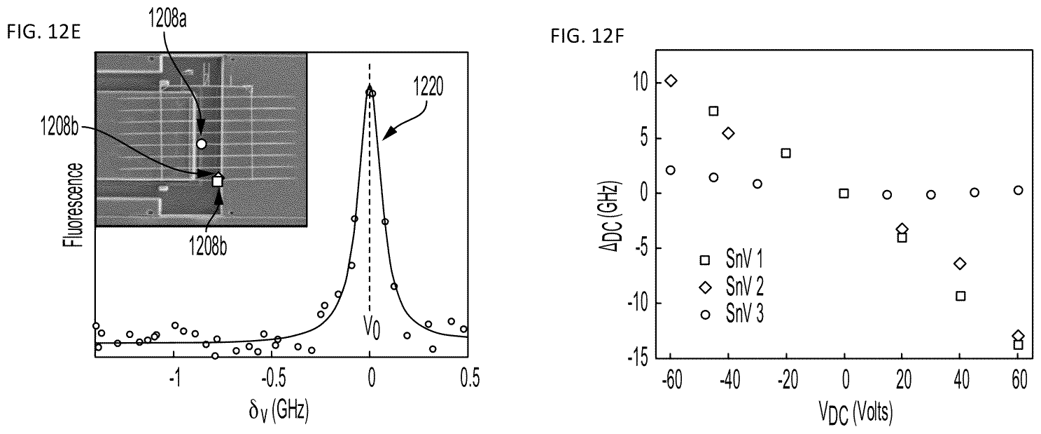

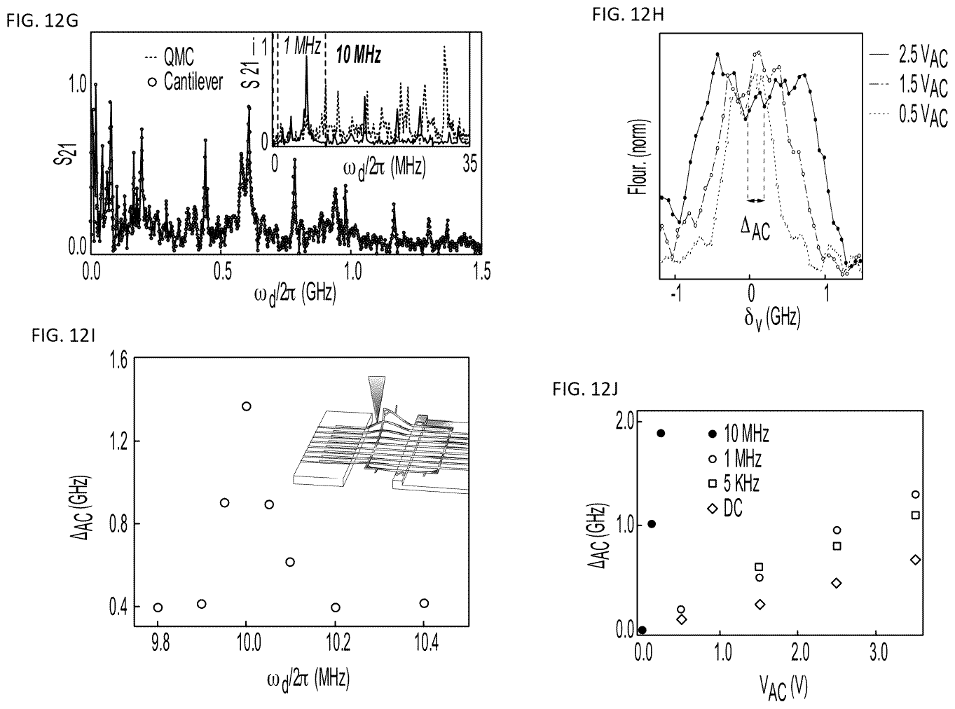

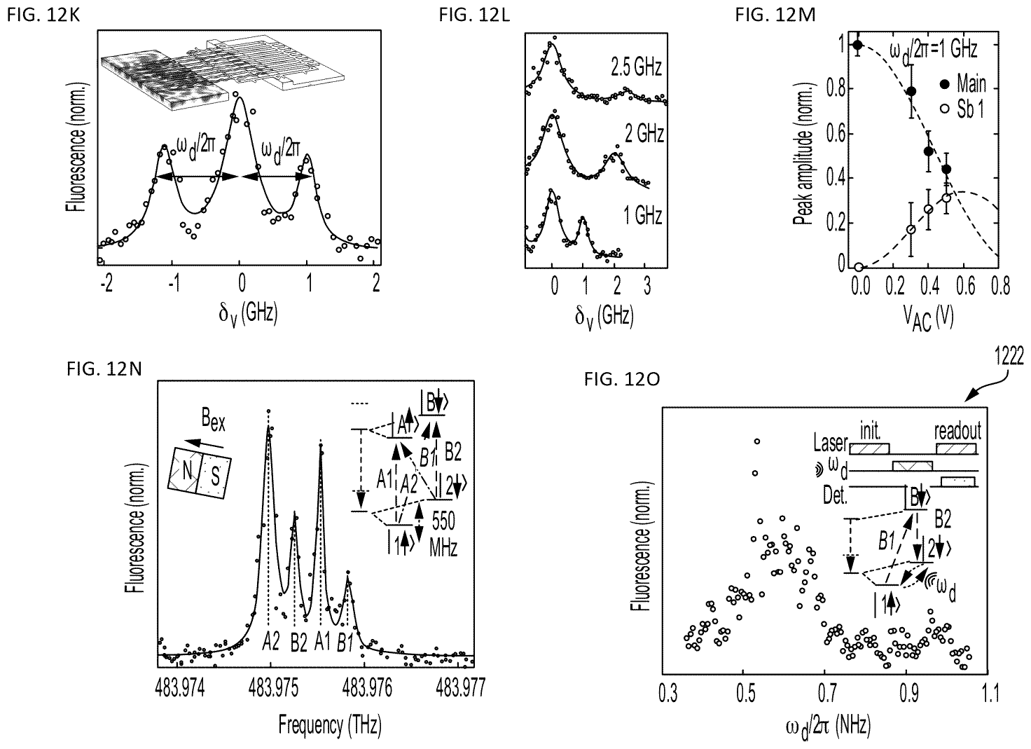

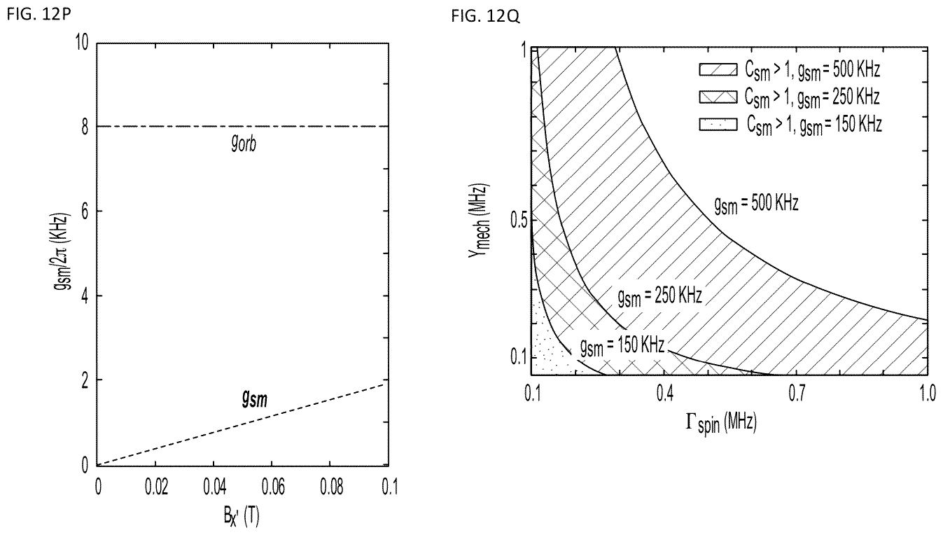

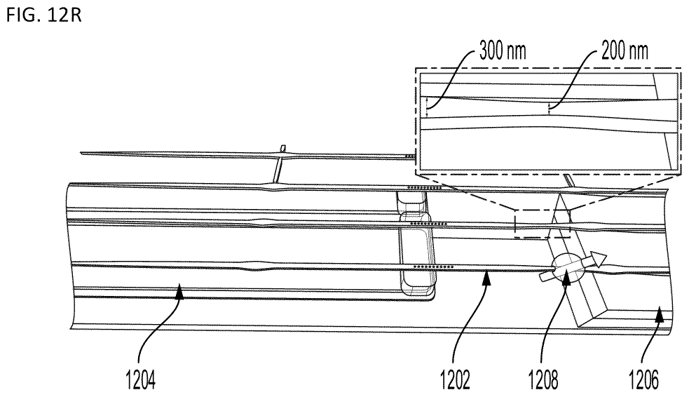

A system for piezoelectric control of qubits in atom-like defect sites may be implemented using piezoelectric cantilevers mechanically coupled to a heterogeneously integrated diamond quantum microchiplet (QMC) that hosts implanted tin vacancy (SnV) defects. FIGS. 12A-12R show example data and diagrams associated with such a device.

As shown in FIGS. 12A-12B and 12R, a piezoelectric cantilever 1204 may mechanically couple to a QMC comprising on-chip photonic (diamond) waveguides 1202 that host implanted SnVs 1208. The QMC comprising waveguides 1202 may resemble the assembly of waveguides 902 or 1002 shown in FIGS. 9 and 10, respectively. Cantilever 1204 may have one or more features of cantilever 404, 504, 604, 700, 904, 1004, and/or 1100 shown in FIGS. 4-7 and 9-11.

On-chip waveguides 1202 may optically couple to the QMC via inverse tapering, providing a scalable interface between SnV fluorescence and an active photonic integrated circuit (PIC) 1206 comprising SiN waveguides 1216. SnVs 1208 may be excited through free space perpendicular to the QMC. Trenches 1218 defining the undercut region of cantilever 1204 may confine the mechanical displacement of waveguides 1202 and prevent crosstalk between actuators. This may enable a compact device footprint without sacrificing operational bandwidth.

Under an applied voltage V(t)=V_{DC}+V_{AC}sin(ω_{d}t), cantilever 1204 may deflect vertically, introducing controllable uni-axial strain ε(t)=ε_{DC}+ε_{AC}sin(ω_{d}t) along the x-axis of the attached diamond nanobeams (FIG. 12B). This strain may break the orientational degeneracy of SnVs 1208 in the nanobeam, with axial and transverse SnVs experiencing a distinct strain tensor and correspondingly different deformation of their orbital states under ε(t). These perturbations to the orbital state charge distribution may lead to a shift in energy of the optical transitions in the SnV characteristic emission spectrum, Δₙ(t)=Δ_{n,DC}+Δ_{n,AC}sin(ω_{d}t), where n indicates the particular orbital transition. Axial SnV orbital states may primarily experience a common mode shift due to strain along their dipole axis, while transverse SnVs may experience relative shifts and state mixing due to off-axis strain, with the magnitude of Δₙ dependent on the corresponding susceptibility parameter.

Photoluminescence excitation spectroscopy (PLE) may be used to probe Δ_{c}(t). The SnV may be excited with a laser of frequency v, detuned from the c transition by an amount δv. The frequency v of the laser may be swept through resonance (δᵥ=0). Photons collected from the phonon sideband (PSB) may be collected onto a single photon detector. For

$${V}_{A C} = 0 or \frac{{ω}_{d}}{2 π} < {Γ}_{opt}$$

(where Tₒₚₜ is the optical linewidth of the SnV emission) Δc may be measured directly from the shift in v₀ as a function of strain. When

$$\frac{{ω}_{d}}{2 π} > {Γ}_{opt} ,$$

ε(t) may oscillate taster than the SnV radiative lifetime, leading to coupling between the SnV and phonons arising from quantized strain in the vibrating nanobeam. Placing a permanent magnet near the sample may lift the spin degeneracy of the orbital ground states (FIG. 12D). PSB fluorescence may occur under optical excitation of the spin-flipping B1 pathway. Applying an acoustic tone using the cantilever may drive transitions between the Zeeman split spin ground states.

Δ_{DC} under static strain with V_{AC}=0

FIG. 12E shows a PLE spectrum ε(t)=0 for a SnV at the location marked by dot 1208a. A linewidth of 120 MHz for this SnV may be extracted from a Lorentzian fit (curve 1220) to the data. When V_{DC}≠0, Δ_{DC} may increase or decrease linearly depending on the sign of ε (SnV 3 in FIG. 12F—v₀ may be obtained from Lorentzian fits to PLE data). Results from an SnV at a different location within the same device (SnV 1 in FIG. 12 F, marked by dot 1208b in FIG. 12E) and from the same location in a second device (SnV 2 in FIG. 12F, marked by dot 1208c) are also shown in FIG. 12F. The device may display over 20 GHz frequency tuning for SnVs located in a region of the QMC under high DC strain while on-chip power dissipation remains below 1 nW, even at voltages as high as 60 V.

Frequency-dependent behavior

Data showing the frequency-dependent behavior of the device under application of a voltage V_{AC}sin(ω_{d}t) to the cantilever are shown in FIGS. 12G-12J. FIG. 12G specifically shows mechanical resonances extending to GHz frequencies. For

$$\frac{{ω}_{d}}{2 π} < {Γ}_{opt} ε ( t )$$

under AC driving may be a broadened resonance in the PLE spectrum of SnVs, with a width equivalent to 2Δ_{AC}, where Δ_{AC} is the energy shift of the SnV transition at V_{AC} (FIG. 12H).

$$\frac{{ω}_{d}}{2 π}$$

FIG. 12I shows Δ_{AC} measured with V_{AC}=0.25 Vₚₚ for SnV 2 as is increased through the mechanical resonance at 10 MHz shown in in FIG. 12G. Voltage dependence

$$\frac{{ω}_{d}}{2 π}$$

reveals Δ_{AC}˜0.1 GHz for values far from mechanical resonances (1 MHz, 5 kHz, and DC) vs 1.9 GHz at 0.25 V_{AC} under resonant driving at 10 MHz, an almost 20-fold increase. This amplified resonant response may allow rapid frequency tuning of integrated quantum memories with ultra-low on-chip power dissipation.

Acoustic control of SnVs

The large bandwidth of the device can allow engineered coupling between acoustic

$$\frac{{ω}_{d}}{2 π} > {Γ}_{opt} ,$$

vibrations in the nanobeam and SnVs in the QMC. In the resolved-sideband regime, where the rapidly oscillating ε(t) may lead to coupling with virtual states in the PLE spectrum

$$\frac{{ω}_{d}}{2 π} .$$

(FIG. 12K) at integer multiples of the drive frequency w im V_{AC} maintained at 0.5 V, sidebands up to 2.5 GHz may be observed (FIG. 12L), reflecting the large operational bandwidth of the device.

The relative amplitudes of the sidebands and main peak may be fit to Bessel functions of the first kind (FIG. 12M), with the population of the kth sideband given by

$${P}_{k} ∼ {\vert {J}_{k} ( 2 {( \frac{{g}_{orb}}{{ω}_{d}} )}^{2} < n > ) \vert}^{2}$$

where <n> is the phonon occupation number of the mechanical mode driven at V_{AC}, and g_{orb} is the single-phonon coupling rate for the SnV orbital states, arising from strain due to zero-point fluctuations in the diamond nanobeam g_{orb} may be about 2000 Hz at the location of SnV. An axially oriented SnV may have a maximum single-phonon coupling rate of about 8000 Hz, while a transversely oriented SnV may have a maximum single-phonon coupling rate of about 104 Hz. For V_{AC}<0.5 V, <n>˜10⁹. Under these conditions, the calculated on-chip dissipated power may remain below 0.5 μW for frequencies exceeding the 2.5 GHz bandwidth of the device.

The spin-degenerate orbital ground states of the SnV may be split using a permanent magnet. For maximum spin-orbit mixing, the magnetic field may be oriented perpendicular to the SnV dipole axis, and the proximity of the magnet may be adjusted until the Zeeman splitting observed in the PLE spectrum (FIG. 120) roughly aligns with the approximately 600 MHz mechanical resonance of the device. The SnV spin may be initialized to |2↓> by optically pumping the spin-flipping B1 transition. The spin population in the |1↑> state may be probed following the application of a 150 ns acoustic pulse from the cantilever.

FIG. 12P shows the phonon sideband fluorescence under an optical readout pulse resonant with the B1 transition as the acoustic frequency is swept from 350 mHz to 1.05 GHz,

$$\frac{{ω}_{d}}{2 π} ∼ 550 MHz ,$$

following the application of a pulse sequence 1222. When near the frequency separation of the spin states shown in FIG. 120, counts may increase due to transfer of spin population from |2↓> back to |1↑> by the resonant acoustic pulse, indicating successful manipulation of the SnV electron spin.

For SnVs, the effective spin-phonon coupling rate, gₛₘ may depend on the degree of spin-orbit mixing and may asymptotically approach g_{orb} as a function of the transverse magnetic field. FIG. 12Q shows a plot of gₛₘ as a function of transverse magnetic field in SnV coordinates, Bₓ, for a spin transition frequency of 1 GHz and

$$\frac{{ω}_{d}}{2 π} = 1 GHz .$$

The transverse magnetic field may be about 0.08±0.02T at the sample for a surface field of 0.77T placed 0.5 cm from the sample. Under these conditions, gₛₘ may be about 1.5±0.35 KHz.

Applying a strong, optimally oriented transverse magnetic field may allow gₛₘ to be increased near the limit of g_{orb} for large enough fields. The higher frequency mechanical modes present in the device may allow coupling with phonons matched to a Zeeman splitting of 2.5 GHz. Adjustments the cantilever stiffness and undercut (e.g., by changing the metal composing or SiO₂ cladding of the cantilever in order to change the mechanical behavior of the cantilever) may allow operation at higher mechanical frequencies which, in turn, may allow faster and more efficient spin manipulation. Cooling our device to temperatures below 5.5 K may allow the Rabi frequencies and spin coherence times achievable in our device to be characterized.

g_{orb} may be increased to raise the limit to the spin-phonon coupling rate by increasing the strain experienced by integrated color centers due to zero-point motion of the structure. Engineering constrictions in the nanobeam width may further confine the mechanical mode and enhance zero-point strain for color centers located in the concentrators. For example, narrowing a portion of the nanobeam can concentrate the strain at the narrow portion, thereby increasing the amount of strain coupling to defect sites in the narrow portion.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

Any of the systems, methods, techniques, and/or features disclosed herein may be combined, in whole or in part, with any other systems, methods, techniques, and/or features disclosed herein.

1. A photonic device comprising:
a photonic chip;
a piezoelectric cantilever; and
a photonic waveguide comprising one or more embedded point defect sites, wherein:
the photonic waveguide is optically coupled to the photonic chip, and
the photonic waveguide is mechanically coupled to the piezoelectric cantilever such that movement of the piezoelectric cantilever induces a strain in the photonic waveguide.

2. The photonic device of claim 1, wherein applying an electrical signal to the piezoelectric cantilever causes the cantilever to move.

3. The photonic device of claim 2, wherein a direction and a magnitude of movement of the piezoelectric cantilever depend on a voltage of the applied electrical signal.

4. The photonic device of claim 1, wherein the piezoelectric cantilever comprises:
a piezoelectric layer;
a first electrode layer disposed on a first side of the piezoelectric layer;
a second electrode layer disposed on a second side of the piezoelectric layer; and
a base layer disposed beneath the piezoelectric layer, the first electrode, and the second electrode.

5. The photonic device of claim 4, wherein the piezoelectric layer comprises aluminum nitride.

6. The photonic device of claim 4, wherein the first and second electrode layers are collectively configured to apply an electric field across the piezoelectric layer.

7. The photonic device of claim 4, wherein the first and second electrode layers are formed from aluminum.

8. The photonic device of claim 4, wherein the base layer comprises silicon dioxide.

9. The photonic device of claim 4, wherein the base layer comprises amorphous silicon.

10. The photonic device of claim 1, wherein the piezoelectric cantilever comprises an optical layer, wherein:
at least a portion the photonic waveguide is embedded within the optical layer, and
the optical layer comprises a binding layer that surrounds a portion of the photonic waveguide embedded within the optical layer and is configured to mechanically couple the portion of the photonic waveguide to the piezoelectric layer.

11. The photonic device of claim 1, wherein the photonic waveguide is formed from diamond.

12. The photonic device of claim 1, wherein the point defect sites comprise Group IV defect sites.

13. The photonic device of claim 12, wherein the point defect sites comprise tin vacancy (SnV) defect sites.

14. The photonic device of claim 1, wherein the point defect sites are configured to emit photons when excited by a light source.

15. The photonic device of claim 14, wherein a frequency of the photons emitted by the point defect sites depends on the strain in the photonic waveguide induced by the movement of the piezoelectric cantilever.

16. A method comprising:
applying an electrical signal to a piezoelectric cantilever, wherein:
the piezoelectric cantilever is mechanically coupled to a photonic waveguide comprising one or more embedded point defect sites, and the photonic waveguide is optically coupled to a photonic chip;
wherein applying the electrical signal to the piezoelectric cantilever induces movement in the piezoelectric cantilever, and
wherein the movement of the piezoelectric cantilever induces a strain in the photonic waveguide.

17. The method of claim 16, wherein applying the electrical signal comprises:
exciting a defect site of the one or more embedded point defect sites with excitation light;
measuring a frequency of a photon emitted by the excited defect site;
determining a frequency shift based on the measured frequency of the emitted photon; and
determining the electrical signal to be applied to the piezoelectric cantilever based on the frequency shift.

18. The method of claim 17, wherein determining the frequency shift comprises comparing the measured frequency of the emitted photon to a reference frequency.

19. The method of claim 18, wherein the reference frequency is associated with a desired quantum state for a qubit encoded in the defect site.

20. The method of claim 16, wherein the electrical signal comprises a direct current (DC) signal.

21. The method of claim 16, wherein the electrical signal comprises an alternating current (AC) signal.

22. The method of claim 21, wherein a frequency of the AC signal is approximately equal to a mechanical resonance frequency of the piezoelectric cantilever.

23. The method of claim 21, wherein a voltage of the alternating current signal is approximately equal to 0.5 V.

24. The method of claim 16, comprising:
applying a magnetic field to a defect site of the one or more point defect sites using a permanent magnet;
exciting the defect site from a first spin state to a second spin state; and
applying the electrical signal to the piezoelectric cantilever, wherein the electrical signal comprises an alternating current signal with a frequency approximately equal to a separation frequency between the first spin state and the second spin state.

25. The method of claim 24, wherein the magnetic field is oriented perpendicular to a dipole axis of the defect site.

26. A non-transitory computer readable storage medium storing instructions that, when executed by one or more processors of an electronic device, cause the device to:
apply an electrical signal to a piezoelectric cantilever, wherein:
the piezoelectric cantilever is mechanically coupled to a photonic waveguide comprising one or more embedded point defect sites, and the photonic waveguide is optically coupled to a photonic chip;
wherein applying the electrical signal to the piezoelectric cantilever induces movement in the piezoelectric cantilever, and
wherein the movement of the piezoelectric cantilever induces a strain in the photonic waveguide.
